(19) United States
(12) Patent Application Publication
(10) Pub. No.: US 2026/0368293 A1
(43) Pub. Date: Nov. 19, 2026

(54) METHOD FOR AUTHENTICATING OR IDENTIFYING AN INDIVIDUAL BASED ON A SPEECH SOUND SIGNAL

(71) Applicant: WORLDLINE, Puteaux (FR)

(72) Inventors: Li GUO, Villeneuve D'ascq (FR); Florian PIOTROWSKI, Wingles (FR)

(73) Assignee: WORLDLINE, Puteaux (FR)

(21) Appl. No.: 19/137,560

(22) PCT Filed: Dec. 6, 2023
(86) PCT No.: PCT/EP2023/084499

§ 371 Date: Jun. 10, 2025

(30) Foreign Application Priority Data
Dec. 15, 2022 (FR) 22/13491

(51) Int. Cl. G06F 21/32; G10L 17/04

(52) U.S. Cl. CPC G06F 21/32; G10L 17/04

(57) ABSTRACT

A method for authenticating or identifying an individual, the method includes implementing steps of: (a) obtaining an audio speech signal of the individual in a candidate environment, acquired by a microphone of the candidate terminal; (b) determining on the basis of the audio signal—a first vector representative of the identity of the individual by applying a first upstream model; and—a second vector representative of the candidate terminal by applying a second upstream model, and/or a third vector representative of the candidate environment by applying a third upstream model; (c) authenticating or identifying the individual based on the result of applying:—to the first vector a first downstream function model; and—to the second vector a second downstream function model and/or to the third vector a third downstream model.

### GENERAL TECHNICAL FIELD

The present invention relates to the field of biometric recognition, in particular based on the voice. More specifically, it concerns a method for authenticating or identifying an individual based on a speech sound signal.

### STATE OF THE ART

The biometric authentication/identification is the automatic recognition of a person using distinctive features, that is to say, automatically measurable, robust and distinctive physical (biological) characteristics or personal behavioural features that can be used to verify (in the case of authentication) or determine (in the case of identification) the identity of an individual. The biometric technologies improve the security and the convenience of use.

Several biometric information was used such as fingerprints, face, iris, etc.

We also know about voice biometric recognition, called speaker recognition (SR), in which the voice is used as a biometric feature by focusing on the extralinguistic information of the voice signal. The individual variations between speakers have two essential origins. First, the morphological characteristics of the speech device are different for each speaker, regardless of the pronounced sentence. Second, the same sentence is not pronounced in the same way by two speakers. Indeed, it is observed differences in the speech rates, in the extent of speech variations or even differences related to their sociocultural background.

The automatic speaker recognition can be text-dependent or text-independent. In text-dependent speaker recognition systems, the speaker is asked to pronounce a specific string of words in both the training and recognition phases, whereas in text-independent systems, the speaker recognition system recognizes the speaker independently of the pronunciation of a specific sentence, see the document Fathi E. Abd El-Samie. Information Security for Automatic Speaker Identification. In Fathi E. Abd El-Samie, editor, Information Security for Automatic Speaker Identification, SpringerBriefs in Speech Technology, pages 1-122. Springer, New York, NY, 2011.

Most state-of-the-art solutions use stepwise algorithms. A stepwise speaker verification system is composed of an upstream (or front-end) model for extracting speaker features and a downstream (or back-end) model for computing speaker characteristics similarity. The front-end model transforms an utterance in the time domain or time-frequency domain into a high-dimensional characteristic vector. The back-end model first computes a similarity score between the enrollment and test speaker characteristics and then compares the score with a threshold.

However, these known systems can be fooled by spoofing attacks, such as impersonation (imitations or twins), replay (pre-recorded audio), text-to-speech (converting text to spoken words), and voice conversion (converting speech from source speaker to target speaker).

The present invention improves the situation.

### PRESENTATION OF THE INVENTION

The present invention therefore relates, according to a first aspect, to a method for authenticating or identifying an individual, the method being characterized in that it comprises the implementation by data processing means of a candidate terminal and/or a first server of steps of:
(a) Obtaining a speech sound signal of said individual in a candidate environment, acquired by a microphone of the candidate terminal;
(b) Determining from said sound signal of
   a first vector representing the identity of the individual by applying a first upstream model; and
   a second vector representative of said candidate terminal by applying a second upstream model, and/or a third vector representative of said candidate environment by applying a third upstream model.
(c) Authenticating or identifying said individual based on the result of the application:
   to the first vector of a first downstream model depending on a base of vectors representing the identity of reference individuals; and
   to the second vector of a second downstream model depending on a base of vectors representative of reference terminals associated with said reference individuals and/or to the third vector of a third downstream model depending on a base of vectors representative of reference environments associated with said reference individuals.

According to advantageous and non-limiting characteristics:

In the step (c), the individual is identified or authenticated if:
the first vector coincides with a vector representative of the identity of an expected reference individual, from said base of vectors representative of the identity of reference individuals; and
the second vector coincides with a vector representative of a reference terminal associated with said expected reference individual, of said base of vectors representative of reference terminals associated with said reference individuals, and/or
the third vector coincides with a vector representative of a reference environment associated with said expected reference individual, of said base of vectors representative of reference environments associated with said reference individuals.

The step (b) is a step of determining from said audio signal:
the first vector by applying the first upstream model;
the second vector by applying the second upstream model; and
the third vector by applying the third upstream model.

Step (c) is a step of authenticating or identifying said individual based on the result of the application:
to the first vector of the first downstream model;
to the second vector of the second downstream model; and
to the third vector of the third downstream model.

At least one of the first, second, and third downstream models is a model learned on a base of reference audio signals associated with combinations of a reference individual, a reference terminal, and a reference environment.

At least one of the first, second, and third upstream models is a model learned on one of said bases of vectors representative of the identity of reference individuals, vectors representative of reference terminals associated with said reference individuals, or vectors representative of reference environments associated with said reference individuals.

Each of the first, second, third upstream model is a learned model.

The method comprises a prior step (a0) of learning, by data processing means of a second server, the parameters of said first, second, third upstream model.

Said learning is implemented in a self-supervised manner from said base of reference audio signals associated with combinations of a reference individual, a reference terminal and a reference environment.

Said learning comprises, for each of a plurality of reference signals of said reference audio signal base, a pre-processing selecting first, second and/or third different parts of the information of said reference audio signal, on which the first, second and/or third upstream models are applied.

Said learning comprises, for each of said plurality of reference signals of said reference audio signal base:
the implementation of said pre-processing so as to select first, second and/or third different parts of the information of said reference audio signal,
for each selected part of said reference audio signal the partial masking of said part;
the determination of:
   a first learning vector by applying the first upstream model to the first masked part of the reference audio signal; and
   a second learning vector by applying to the second masked part of the reference audio signal a second upstream model, and/or a third learning vector by applying to the third masked part of the reference audio signal a third upstream model.
attempting to reconstruct from each of the first, second and third training vectors of said reference audio signal.

The step (a0) further comprises the generation of said bases of vectors representative of the identity of reference individuals, of vectors representative of reference terminals associated with said reference individuals or of vectors representative of reference environments associated with said reference individuals, by applying to said reference audio signals the first, second and third learned upstream models.

According to a second aspect, the invention concerns a method for enrolling data for authentication or identification of a reference individual, the method being characterized in that it comprises the implementation by data processing means of a first and/or a second server of steps of:
(A) Obtaining a speech sound signal from said reference individual in a reference environment, acquired by a microphone of a reference terminal;
(B) Determining from said sound signal of
   a first vector representing the identity of the reference individual by applying a first upstream model; and
   a second vector representative of said reference terminal by applying a second upstream model, and/or a third vector representative of said reference environment by applying a third upstream model.
(C) Storing on data storage means of the first server or the second server:
   of the first vector in a base of vectors representing the identity of reference individuals; and
   of the second vector in a base of vectors representative of reference terminals associated with said reference individuals and/or of the third vector in a base of vectors representative of reference environments associated with said reference individuals.

According to a third aspect, the invention concerns an equipment for authenticating or identifying an individual, characterized in that it comprises data processing means configured to:

Obtain a speech sound signal of said individual in a candidate environment, acquired by a microphone of a candidate terminal;

Determine from said sound signal:
a first vector representing the identity of the individual by applying a first upstream model; and
a second vector representative of said candidate terminal by applying a second upstream model, and/or a third vector representative of said candidate environment by applying a third upstream model.
authenticate or identify said individual based on the result of the application:
to the first vector of a first downstream model depending on a base of vectors representing the identity of reference individuals; and
to the second vector of a second downstream model depending on a base of vectors representative of reference terminals associated with said reference individuals and/or to the third vector of a third downstream model depending on a base of vectors representative of reference environments associated with said reference individuals.

According to a fourth aspect, the invention concerns data enrollment equipment for authentication or identification of a reference individual, characterized in that it comprises data processing means configured to:

Obtain a speech sound signal of said reference individual in a reference environment, acquired by a microphone of a reference terminal;

Determine from said audio signal:
a first vector representing the identity of the reference individual by applying a first upstream model; and
a second vector representative of said reference terminal by applying a second upstream model, and/or a third vector representative of said reference environment by applying a third upstream model.

Store:
the first vector in a base of vectors representing the identity of reference individuals; and
the second vector in a base of vectors representative of reference terminals associated with said reference individuals and/or the third vector in a base of vectors representative of reference environments associated with said reference individuals.

According to a fifth and a sixth aspect, the invention concerns a computer program product comprising code instructions for executing a method according to the first aspect of authenticating or identifying an individual or according to the second aspect of enrolling data for authenticating or identifying a reference individual; and a storage means readable by computer equipment on which is recorded a computer program product comprising code instructions for executing a method according to the first aspect of authenticating or identifying an individual or according to the second aspect of enrolling data for authenticating or identifying a reference individual.

### PRESENTATION OF FIGURES

Other characteristics and advantages of the present invention will become apparent from the following description of a preferred embodiment. This description will be given with reference to the appended drawings in which:

FIG. 1 is a diagram of a system for implementing the method according to the invention;

FIG. 2 schematically illustrates the principle of the method according to the invention;

FIG. 3a is a flowchart representing the steps of a first embodiment of the invention;

FIG. 3b is a flowchart representing the steps of a second embodiment of the invention;

FIG. 4 illustrates a self-supervised learning in a preferred embodiment of the method according to the invention.

### DETAILED DESCRIPTION

### Architecture

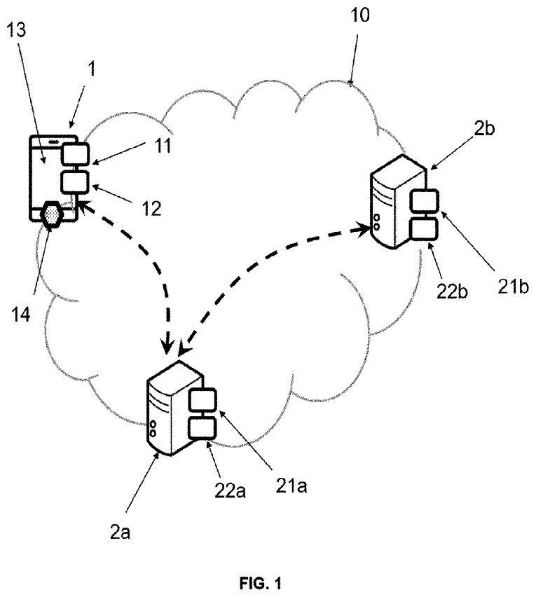

The present invention concerns a method for authenticating or identifying an individual, that is to say for determining or verifying the identity of the individual presenting himself in front of a terminal 1, in a system such as represented in FIG. 1, for example for the implementation of a transaction by said individual, but also for access control, the guaranteed geolocation, etc.

Said individual whose identity is sought to be verified is considered a «candidate», as opposed to «reference» individuals whose identity is known. Said system comprises the terminal 1 to which the individual, called a «candidate» terminal, has access, as opposed to so-called «reference» terminals which are known to be held or at least accessible by a reference individual. Note that for convenience, in the remainder of this description, the numerical reference 1 will be used indiscriminately for a candidate or reference terminal.

The terminal 1 comprises data processing means 11 such as a processor, and where appropriate data storage means 12 (a memory), interface means 13 (a screen). This is typically a mobile terminal of the smartphone type, but alternatively the terminal 1 can be a tablet, a personal computer, but also fixed equipment such as an access control terminal, or any other equipment owned and controlled by an entity with whom the authentication/identification must be carried out.

Moreover, and as will be seen, the terminal 1 comprises a microphone 14 for recording audio signals (in the time domain or the time-frequency domain). This microphone 14 is generally integrated, but it could also be a peripheral connected to the rest of the terminal 1, for example that of a headset connected (wired or not) to a smartphone-type terminal 1. The assembly then constitutes the terminal 1, and as will be explained later, it will be understood that the «smartphone alone» and the «smartphone with the connected headset» must be considered as two different candidate terminals.

The present method is implemented by the terminal 1 and/or a first server 2a which can be the same as the terminal 1, or remote and connected by a network 10 such as the Internet. Advantageously, there is a second server 2b (which is a learning device as we will be seen), typically remote (i.e. in the network 10), but which could be the same as the first server 2a. The first server 2a can for example be the authentication server of a banking entity.

Each server 2a, 2b also has data processing means 21a, 21b (typically a processor) and data storage means 22a, 22b (a memory, for example a hard disk). As will be seen, the data processing means 21b of the second server 2b (but also those of the first server 2a) can store at least one learning database. As will be seen, there can be in particular three learning databases:
A base of vectors representing the identity of reference individuals,
A base of vectors representative of reference terminals associated with said reference individuals,
A base of vectors representative of reference environments associated with said reference individuals.

In a particularly preferred manner, one can also (or alternatively) have a single base of «raw» reference audio signals associated with combinations of a reference individual, a reference terminal and a reference environment. The vectors of the other three bases can, as will be seen, be reconstructed from this base.

### Method

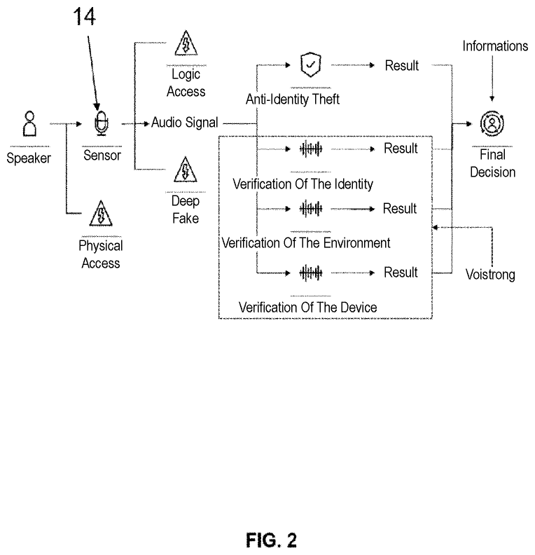

The present method concerns a voice-based biometric authentication or identification method capable of authenticating the identity of the speaker, his environment and/or his terminal (preferably all three) from a single utterance as illustrated in FIG. 2. We can indeed see that we are able on the same speech sound signal to have not only enough to identify the speaker, but also his environment, and even more surprisingly his terminal. For this last point, we can even see that two terminals of the same model (and therefore with the same microphone) are still distinguishable due to imperceptible differences in manufacturing, wear, and accessories (for example, a smartphone case significantly influences the audio signal).

Unlike classical approaches that verify a single factor (identity), this one improves decision-making and system security by combining two or even three factors. Moreover, the use of this solution is very diverse.

As explained, the steps of the present method can be implemented by the data processing means 11 of the candidate terminal 1 and/or by the data processing means 21a of the first server 2a. In particular, everything can be implemented on the terminal 1 for example in a case of authentication of the user of the terminal to access an application, or everything can be implemented by the first server 2a in the case of authentication of the user for validation of a banking transaction, or even partially on each side for example for identification of the user wishing to access an online service.

In FIG. 2, we see the various possible sources of attacks: physical access to microphone 14, logical access to the audio signal, and the use of a deepfake. These three attacks are made impossible by the combination of the three factors, since each time at least one factor cannot be reproduced. Note that in a known manner we can add in parallel a classic anti-spoofing (anti-identity theft) mechanism for example for detecting the living.

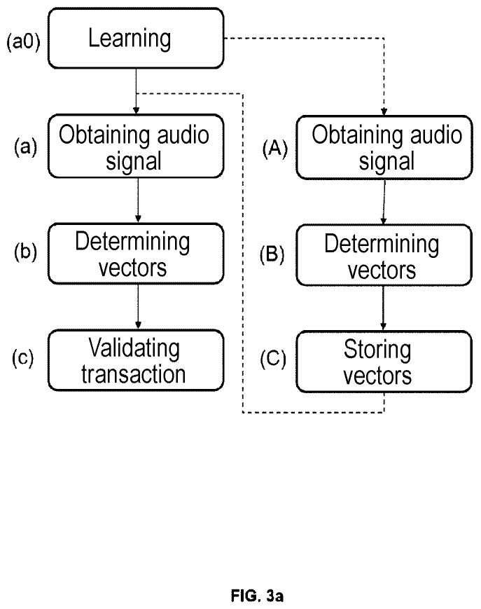

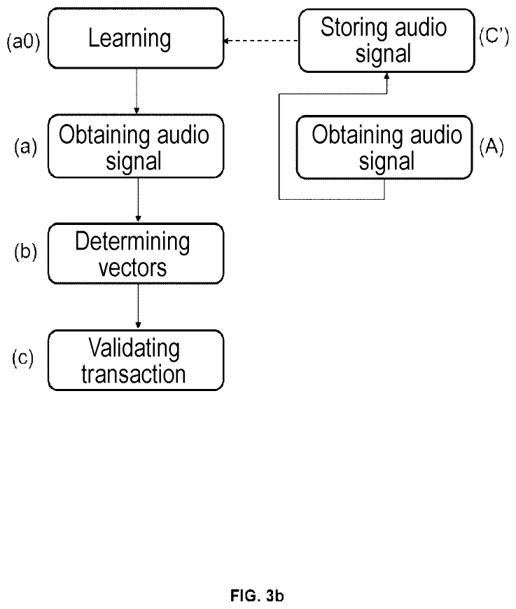

With reference to FIGS. 3a and 3b, the present method begins with a step (a) of obtaining a speech sound signal of said individual in a candidate environment, acquired by a microphone 14 of the candidate terminal 1. More precisely, step (a) comprises either directly the acquisition of said audio signal by the terminal 1, or the reception of said signal (where appropriate encrypted) by the server 2a from the terminal 1.

The term «speech sound signal of said individual» is meant the audio recording of the individual «speaker», i.e. pronouncing a sentence (predetermined or not), the sentence pronounced being designated speech. It will be noted that we are not limited here to any speaker recognition technique, so that said speech is either:
A specific predetermined phrase;
An expected sentence, that is to say for example the terminal 1 displays the sentence to be pronounced, in challenge/response mode;
Any sentence.

Moreover, the sentence is pronounced in a candidate environment, that is to say, in a context that influences the audio signal and in particular its «background sound», which can be a specific noise, other words, music, or even silence. The environment here refers to the place but also the time, since the same place can be very different during the day and at night.

For example:
in the street we can hear the noise of cars in the background;
in offices during the day, you can hear people talking;
in a commercial place during the day you will hear music
in a small closed office you will hear no other voice but reverberation
etc.

In a step (b), the data processing means 11 or 21a determine from said audio signal:
a first vector representing the identity of the individual by applying a first upstream model, and
a second vector representative of said candidate terminal 1 by applying a second upstream model and/or a third vector representative of said candidate environment by applying a third upstream model, advantageously both (i.e. we have three vectors).

In other words, up to three so-called upstream (or «front-end») models are applied independently to the audio signal so as to extract the first, second and/or third vectors, which are high-dimensional characteristic vectors. The upstream models act as encoders. Note that step (b) may comprise, before the application of the models, that of a predetermined basic encoder to simply digitize the signal.

Finally, in a step (c), the data processing means 11 or 21a authenticate/identify said individual based on the result of the application:
to the first vector a first downstream model function of a base of vectors representative of the identity of reference individuals, and
to the second vector a second downstream model depending on a base of vectors representative of reference terminals associated with said reference individuals and/or to the third vector a third downstream model depending on a base of vectors representative of reference environments associated with said reference individuals, advantageously both (i.e. three downstream models are applied).

In other words, up to three so-called downstream (or «back-end») models are applied respectively on the first, second and/or third vectors as authentication/identification factors.

Typically, the individual is identified/authenticated if (the results of downstream models are that):
the first vector coincides with a vector representing the identity of an expected reference individual, of said base (in the case of authentication we have a single expected reference individual, whereas in the case of identification it can be any reference individual, and we have more precisely a determination of the expected reference individual as being the one whose vector representing the identity coincides with the first vector); and
the second vector coincides with a vector representative of a reference terminal associated with said expected reference individual (forming expected reference terminal—one can have one or more reference terminals associated with a reference individual), of said base, and/or
the third vector coincides with a vector representing a reference environment associated with said expected reference individual (forming expected environment—one can have one or more reference environments associated with a reference individual, and where appropriate authorized combinations, for each reference individual, of an environment and a reference terminal), of said base

It is therefore understood that we have two or three independent authentication/identification processes but applied to the same input audio signal, and that each process must have a positive result, so as to have a «strong» solution.

In practice, up to 6 independent models are used between steps (b) and (c): three models for extracting the first, second and third vectors (called upstream models), and three models applied to the vectors (called downstream models).

Each of these models can be a predefined algorithm or an artificial intelligence model, learned in particular on said vector bases forming a learning base, or directly the base of reference audio signals, a particularly preferred embodiment will be detailed later. It should be noted that generally speaking, using two layers of models is called «stepwise» and is known to those skilled in the art as explained in the introduction. Here, what is really original is to use several in parallel from the same audio signal.

For example, the downstream models can simply perform a comparison between the input vector (first, second or third vector) and each corresponding reference vector, by calculating a so-called similarity score, for example from a distance calculation, to finally compare it to a threshold. We consider that there is coincidence if the score exceeds said threshold (i.e. the distance is less than a minimum acceptable distance). Note that the thresholds can be predetermined, or dynamic, depending on the context (for example a given application can apply a strong credit to the device), or even depending on the result of the other models (for example we can predict that if the first model finds an extremely high similarity score, we are already almost certain of the identity of the individual, and therefore we will tolerate lower scores for the other two factors. Conversely, if the first model finds a similarity score just at the threshold, we have more doubts, and therefore we will require higher scores for the other two factors).

The three similarity scores can further be used to calculate an overall risk score.

Alternatively, the downstream models can be classification models associating with a first/second/third vector a class designating a reference identity/terminal/environment among a set of possibilities.

For the upstream models, we know in particular artificial intelligence models adapted to the encoding of audio signal characteristics for SR, in particular RNN-type neural networks (recurrent neural networks, for example LSTMs or GRUs) or Transformers.

Moreover, the step (b) may comprise a pre-processing selecting, amplifying or correcting different (but not necessarily disjoint) parts of the audio signal information, on the basis of each the vectors are extracted (i.e. the first upstream model is applied to the first part, etc.).

Note that in the case of learned upstream models, we can either still have this pre-processing (in particular to make an increase in the learning data, see below), or assume that the learning will automatically bring out the most discriminating information (i.e. the models are applied to the audio signal as is).

In all cases, we can refer for the upstream models to the document Sanyuan Chen, Chengyi Wang, Zhengyang Chen, Yu Wu, Shujie Liu, Zhuo Chen, Jinyu Li, Naoyuki Kanda, Takuya Yoshioka, Xiong Xiao, Jian Wu, Long Zhou, Shuo Ren, Yanmin Qian, Yao Qian, Jian Wu, Michael Zeng, Xiangzhan Yu, and Furu Wei. Wavlm: Large-scale self-supervised pre-training for full stack speech processing, 2021, and for downstream models to the document Brecht Desplanques, Jenthe Thienpondt, and Kris Demuynck. ECAPA-TDNN: Emphasized Channel Attention, Propagation and Aggregation in TDNN Based Speaker Verification. Interspeech 2020, pages 3830-3834, October 2020. arXiv: 2005.07143.

### Self-Supervised Learning

As explained, typically at least one of the first, second, third upstream model and first, second, third downstream model is a model learned on one of said bases of vectors representative of the identity of reference individuals, of vectors representative of reference terminals associated with said reference individuals or of vectors representative of reference environments associated with said reference individuals.

Preferably, each of the first, second, third upstream model is a learned model.

In this respect, the method advantageously comprises a preliminary step (a0) of learning, on the concerned base(s) (of vectors representative of the identity of reference individuals, of vectors representative of reference terminals associated with said reference individuals or of vectors representative of reference environments associated with said reference individuals), the parameters of the concerned model(s).

In a particularly preferred manner, said bases are not annotated, and the learning is of the self-supervised type. Indeed, it is difficult, if not impossible, to have ground truths of first, second or third vectors of representation of reference audio signals, i.e. we generally only originally have the base of reference audio signals and not the first, second and third associated vectors.

The self-supervised learning (SSL) is a machine learning method, implemented from unlabeled data samples. It can be considered as an intermediate form between supervised and unsupervised learning.

The self-supervised learning derives supervisory signals from the data itself, often taking advantage of the underlying structure of the data. The present technique of the self-supervised learning involves implementing a “pretext” task such as predicting any unobserved or hidden part (or property) of the input (the audio signal) from any observed or unhidden part of the input. Since the self-supervised learning uses the structure of the data itself, it can use a variety of supervisory signals across co-occurring modalities (for example, video and audio) and across large datasets, all without relying on labels.

Thus, the self-supervised learning allows the models to develop a particular representation of the data, sufficiently significant and discriminating to reconstruct a missing part, and therefore adapted for the actual task of authentication/identification of the individual.

To have three different models for the three unlabeled factors, we advantageously use the pre-processing mentioned above (in step (b)) as increase in data: we force the model to focus on only a part of the signal, a part respectively representative of the identity, of the device or of the environment, and we start from this part of the signal. For example:
for the first vector (identity), we select as a first part reverberations and noises
for the second vector (terminal): we select as a second part frequency bands (via low-pass, high-pass, band-pass filters) and/or time bands (via periodic masks).
for the third vector (environment): we select as a third part noises and/or frequency bands (via low-pass, high-pass, band-pass filters) and/or time bands (via periodic masks).

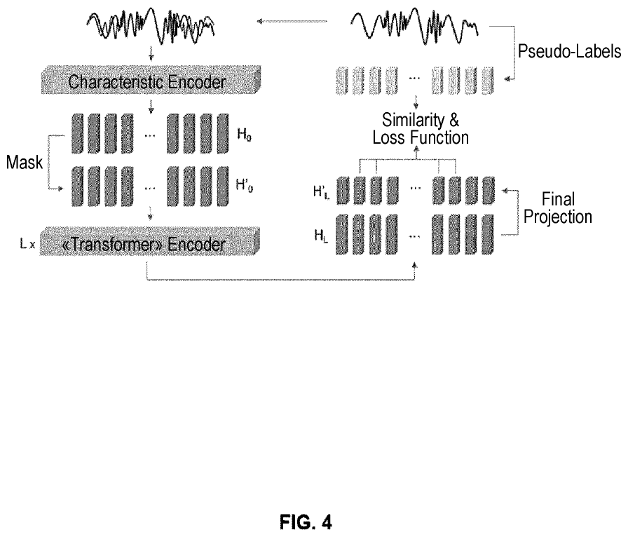

Thus, with reference to FIG. 4 (which represents a factor on the three), step (a0) comprises in the particularly preferred embodiment, for each of a plurality (or even all) of reference signals of said base of reference audio signals associated with combinations of a reference individual, of a reference terminal and of a reference environment:
implementing said pre-processing so as to select first, second and/or third different parts of the information of said reference audio signal,
for each selected part of said reference audio signal partially masking said part;
determining:
   a first learning vector (in practice representative of the identity of the reference individual of said combination associated with the concerned reference signal when the learning is completed) by applying to the first masked part of the reference audio signal the first upstream model; and
   a second learning vector (in practice representative of the reference terminal of said combination when the learning is complete) by applying to the second masked part of the reference audio signal a second upstream model, and/or a third learning vector (in practice representative of the candidate environment of said combination when the learning is complete) by applying to the third masked part of the reference audio signal a third upstream model.
attempting to reconstruct from each of the first, second and third learning vectors said reference audio signal (thus forming a pseudo-label). Learning aims to minimize the reconstruction error by playing on the parameters of the first, second and third models. Note that the term “learning vector” simply means that the vector does not necessarily have any meaning until an advanced stage of the learning.

In the example of FIG. 4, starting from reference audio signals, pseudo-labels are determined by the basic encoder mentioned before (which can be a simple algorithm for digitizing the audio signal).

Starting from the pre-processed versions of this signal (depending on the upstream model that we are trying to learn), we then mask part of the representation by the basic encoder and we ask the first, second or third upstream model in learning (here a transformer) to determine a representative vector (first, second or third vector, depending on the model), then in a final projection we try to find the pseudo-label as ground truth. A loss function evaluates the quality of this prediction and allows the parameters of the model to be varied, until convergence.

In such a self-supervised learning mode only from a base of reference audio signals, step (a0) further comprises generating said bases of vectors representative of the identity of reference individuals, of vectors representative of reference terminals associated with said reference individuals or of vectors representative of reference environments associated with said reference individuals, by applying to the reference signals the first, second and third learned upstream models, typically to then implement step (c) by direct comparison.

At this stage, there may be a slight re-learning of the first, second and third upstream models (what is called fine-tuning), because there may now be several audio signals corresponding to the same individual (for example with different terminals and/or in different environments-we will see enrollment later), this time in a supervised manner.

If the downstream models are artificial intelligence models, we can also learn their parameters in step (a0), in particular conventionally in a supervised manner since we have the labels (the reference audio signals are associated with combinations of a reference individual, of a reference terminal and of a reference environment).

### Enrollment

According to a second aspect, the invention relates to a method for enrolling data for authentication or identification of a reference individual, implemented by the data processing means 21a, 21b of the first server 2a and/or of the second server 2b. As for the authentication or identification method, it can be placed entirely or partially on each of the first and second servers 2a, 2b. According to a preferred embodiment, there is really a separation with the first server 2a having the functions of authentication/identification and those of enrollment, and the second server 2a only those of learning, but the terminal can in practice a part of the steps of authentication/identification and the second server 2b a part of those of enrollment. The two servers 2a, 2b can exchange the databases, but preferably the storage means 22a of the first server 2a store the three bases of vectors representative of the identity of reference individuals, of vectors representative of reference terminals associated with said reference individuals or of vectors representative of reference environments associated with said reference individuals, and the storage means 22b of the first server 2b store the base of reference audio signals associated with combinations of a reference individual, of a reference terminal and of a reference environment.

This method can be initiated by the individual on his terminal 1, assuming that he can authenticate himself separately (for example by other biometric factors and/or in the presence of an authority), but not implemented on the terminal 1 for security reasons.

It is understood that the individual therefore provides his identity, but also his current terminal and/or environment, as a reference terminal and/or environment, for example by naming them. Note that the terminal may be known but in another environment, or on the contrary he may use a new terminal in a known environment.

According to a first embodiment represented by FIG. 3a, with prior learning, the method comprises the steps of:
(A) Obtaining a speech sound signal of said reference individual in the reference environment, acquired by a microphone 14 of the reference terminal 1 (this is the equivalent of step (a) of the method according to the first aspect);
(B) Determining from said sound signal
   a first vector representative of the identity of the reference individual by applying a first upstream model; and
   a second vector representative of said reference terminal 1 by applying a second upstream model, and/or a third vector representative of said reference environment by applying a third upstream model (this is the equivalent of step (b) of the method according to the first aspect);
(C) Storing (typically on the data storage means 22a of the first server 2a):
   the first vector in the base of vectors representative of the identity of reference individuals; and
   the second vector in the base of vectors representative of reference terminals associated with said reference individuals and/or the third vector in the base of vectors representative of reference environments associated with said reference individuals.

Here we understand that the identity of the reference individual is associated with the reference terminal and the reference environment in question, and where appropriate labeled for example with the names given by the individual. And there may well be, as explained, several terminals/environments associated with the same individual.

According to a second embodiment, represented by FIG. 3b, mainly associated with said self-supervised learning, we are satisfied, after step (A) of obtaining a speech sound signal of said reference individual in a reference environment, acquired by a microphone 14 of a reference terminal 1, in a step “(C′)” of directly storing (typically on the data storage means 22b of the second server 2a, 2b) said signal obtained as a reference signal associated with the combination of the identity of the reference individual, of the reference terminal and of the reference environment, in said base of reference audio signals.

Only then is step (a0) implemented (or re-implemented), the models being learned (or updated) and the first, second and third vectors corresponding to said reference signal being generated and stored.

### Servers

According to second and third aspects, the invention relates to the equipment for implementing the methods according to the invention. In particular, the first server 2a and/or the terminal 1 have the role of authentication/identification equipment, and the first server 2a and/or the second server 2b have the role of enrollment equipment. The second server 2b is, by control, the only one in charge of learning.

The authentication/identification equipment comprises data processing means 11, 21a, and generally data storage means 12, 22a. The terminal 1 has an interface 13 and especially a microphone 14.

The means 11, 21a are configured to:
Obtain a speech sound signal from said individual in a candidate environment, acquired by a microphone 14 of a candidate terminal 1;
Determine from said sound signal:
   a first vector representative of the identity of the individual by applying a first upstream model; and
   a second vector representative of said candidate terminal 1 by applying a second upstream model, and/or a third vector representative of said candidate environment by applying a third upstream model.

Authenticate or identify said individual based on the result of the application:
to the first vector of a first downstream model depending on a base of vectors representative of the identity of reference individuals; and
to the second vector of a second downstream model depending on a base of vectors representative of reference terminals associated with said reference individuals and/or to the third vector of a third downstream model depending on a base of vectors representative of reference environments associated with said reference individuals.

The enrollment equipment comprises data processing means 21a, 21b and generally data storage means 22a, 22b. The terminal 1 has an interface 13 and especially a microphone 14.

The means 21a, 21b are configured to:

Either
Obtain a speech sound signal from said reference individual in a reference environment, acquired by a microphone 14 of a reference terminal 1;

Determine from said sound signal:
a first vector representative of the identity of the reference individual by applying a first upstream model; and
a second vector representative of said reference terminal (1) by applying a second upstream model, and/or a third vector representative of said reference environment by applying a third upstream model;

Store:
the first vector in a base of vectors representative of the identity of reference individuals; and
the second vector in a base of vectors representative of reference terminals associated with said reference individuals and/or the third vector in a base of vectors representative of reference environments associated with said reference individuals.

Or

Obtain a speech sound signal of said reference individual in a reference environment, acquired by a microphone 14 of a reference terminal 1; and

Store said obtained signal as a reference signal associated with the combination of the identity of the reference individual, of the reference terminal and of the reference environment, in said base of reference audio signals.

According to a fourth aspect, a set of the terminal 1, of the first server 1 and of the system 2 is proposed. All these elements 1, 2a, 2b can be connected via a network 10.

### Computer Program Product

According to fifth and sixth aspects, the invention relates to a computer program product comprising code instructions for the execution (in particular on the data processing means 11, 21a, 21b) of a method according to the first aspect of the invention for authenticating or identifying an individual or according to the second aspect for enrolling data for authentication or identification of a reference individual, as well as storage means readable by computer equipment (a memory 12, 22a, 22b) on which this computer program product is found.

1. A method for authenticating or identifying an individual, the method wherein it comprises the implementation by data processing means of a candidate terminal and/or of a first server of steps of:
(a) obtaining a speech sound signal of the individual in a candidate environment, acquired by a microphone of the candidate terminal;
(b) determining from the sound signal
a first vector representative of the identity of the individual by applying a first upstream model;
a second vector representative of the candidate terminal by applying a second upstream model; and
a third vector representative of the candidate environment by applying a third upstream model.
(c) authenticating or identifying the individual based on the result of the application:
to the first vector of a first downstream model depending on a base of vectors representative of the identity of reference individuals;
to the second vector of a second downstream model depending on a base of vectors representative of reference terminals associated with the reference individuals; and
to the third vector of a third downstream model depending on a base of vectors representative of reference environments associated with the reference individuals.

2. The method according to claim 1, wherein, in step (c), the individual is identified or authenticated if:
the first vector coincides with a vector representative of the identity of an expected reference individual, of the base of vectors representative of the identity of reference individuals;
the second vector coincides with a vector representative of a reference terminal associated with the expected reference individual, of the base of vectors representative of reference terminals associated with the reference individuals; and
the third vector coincides with a vector representative of a reference environment associated with the expected reference individual, of the base of vectors representative of reference environments associated with the reference individuals.

3. The method according to claim 1, wherein at least one of the first, second, third downstream model is a model learned either on a base of reference audio signals associated with combinations of a reference individual, of a reference terminal and of a reference environment.

4. The method according to claim 1, wherein at least one of the first, second, third upstream models is a model learned on one of the bases of vectors representative of the identity of reference individuals, of vectors representative of reference terminals associated with the reference individuals or of vectors representative of reference environments associated with the reference individuals.

5. The method according to claim 4, wherein each of the first, second, third upstream model is a learned model.

6. The method according to claim 5, comprising a prior step (a0) of learning, by data processing means of a second server, the parameters of the first, second, third upstream model.

7. The method according to claim 6, wherein the learning is implemented in a self-supervised manner from the base of reference audio signals associated with combinations of a reference individual, of a reference terminal and of a reference environment.

8. The method according to claim 6, wherein the learning comprises, for each of a plurality of reference signals of the base of reference audio signals, pre-processing selecting first, second and/or third different parts of the information of the reference audio signal, on which the first, second and/or third upstream models are applied.

9. The method according to claim 7, in combination, wherein the self-supervised learning comprises, for each of the plurality of reference signals of the base of reference audio signals:
implementing the pre-processing so as to select first, second and third different parts of the information of the reference audio signal,
for each selected part of the reference audio signal, partially masking the part;
determining:
a first learning vector by applying to the first masked part of the reference audio signal the first upstream model;
a second learning vector by applying to the second masked part of the reference audio signal a second upstream model, and
a third learning vector by applying to the third masked part of the reference audio signal a third upstream model;
attempting to reconstruct from each of the first, second and third learning vectors the reference audio signal.

10. The method according to claim 8, wherein step (a0) further comprises generating the bases of vectors representative of the identity of reference individuals, of vectors representative of reference terminals associated with the reference individuals or of vectors representative of reference environments associated with the reference individuals, by applying to the reference audio signals the first, second and third learned upstream models.

11. The method for enrolling data for authentication or identification of a reference individual, the method comprising the implementation by data processing means of a first and/or a second server of steps of:
(A) obtaining a speech sound signal of the reference individual in a reference environment, acquired by a microphone of a reference terminal;
(B) determining from the sound signal
a first vector representative of the identity of the reference individual by applying a first upstream model;
a second vector representative of the reference terminal by applying a second upstream model; and
a third vector representative of the reference environment by applying a third upstream model;
(C) storing on data storage means of the first server or of the second server;
the first vector in a base of vectors representative of the identity of reference individuals;
the second vector in a base of vectors representative of reference terminals associated with the reference individuals; and
the third vector in a base of vectors representative of reference environments associated with the reference individuals.

12. An equipment for authenticating or identifying an individual, wherein it comprises data processing means configured to:
obtain a speech sound signal from the individual in a candidate environment, acquired by a microphone of a candidate terminal;
determine from the sound signal:
a first vector representative of the identity of the individual by applying a first upstream model;
second vector representative of the candidate terminal by applying a second upstream model; and
a third vector representative of the candidate environment by applying a third upstream model;
authenticate or identify the individual based on the result of the application:
to the first vector of a first downstream model depending on a base of vectors representative of the identity of reference individuals;
to the second vector of a second downstream model depending on a base of vectors representative of reference terminals associated with the reference individuals; and
to the third vector of a third downstream model depending on a base of vectors representative of reference environments associated with the reference individuals.

13. The equipment for enrolling data for authentication or identification of a reference individual, wherein it comprises data processing means configured to:
obtain a speech sound signal of the reference individual in a reference environment, acquired by a microphone of a reference terminal;
determine from the sound signal:
a first vector representative of the identity of the reference individual by applying a first upstream model;
a second vector representative of the reference terminal by applying a second upstream model; and
a third vector representative of the reference environment by applying a third upstream model;
store:
the first vector in a base of vectors representative of the identity of reference individuals;
the second vector in a base of vectors representative of reference terminals associated with the reference individuals; and
the third vector in a base of vectors representative of reference environments associated with the reference individuals.

14. A computer program product comprising code instructions for executing a method according to claim 1 for authenticating or identifying an individual or the method for enrolling data for authentication or identification of a reference individual, the method comprising the implementation by data processing means of a first and/or a second server of steps of:
(A) obtaining a speech sound signal of the reference individual in a reference environment, acquired by a microphone of a reference terminal;
(B) determining from the sound signal
a first vector representative of the identity of the reference individual by applying a first upstream model;
a second vector representative of the reference terminal by applying a second upstream model; and
a third vector representative of the reference environment by applying a third upstream model;
(C) storing on data storage means of the first server or of the second server;
the first vector in a base of vectors representative of the identity of reference individuals;
the second vector in a base of vectors representative of reference terminals associated with the reference individuals; and
the third vector in a base of vectors representative of reference environments associated with the reference individuals, when the program is executed on a computer.

15. A storage medium readable by computer equipment on which is recorded a computer program product comprising code instructions for executing a method according to claim 1 for authenticating or identifying an individual or the method for enrolling data for authentication or identification of a reference individual, the method comprising the implementation by data processing means of a first and/or a second server of steps of:
(A) obtaining a speech sound signal of the reference individual in a reference environment, acquired by a microphone of a reference terminal;
(B) determining from the sound signal
a first vector representative of the identity of the reference individual by applying a first upstream model;
a second vector representative of the reference terminal by applying a second upstream model; and
a third vector representative of the reference environment by applying a third upstream model;
(C) storing on data storage means of the first server or of the second server;
the first vector in a base of vectors representative of the identity of reference individuals;
the second vector in a base of vectors representative of reference terminals associated with the reference individuals; and
the third vector in a base of vectors representative of reference environments associated with the reference individuals.
